(19) United States
(12) Patent Application Publication
(10) Pub. No.: US 2005/0249063 A1
(43) Pub. Date: Nov. 10, 2005

(54) Method of reactivating servo control system

(75) Inventor: Seng-Ming Chuang, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/121,938

(22) Filed: May 5, 2005

(30) Foreign Application Priority Data
May 6, 2004 (TW) 93112831

(51) Int. Cl. G11B 7/00

(52) U.S. Cl. 369/44.35; 369/44.27; 369/44.29

(57) ABSTRACT

A method of reactivating a servo control systems for applying in an optical disc drive, comprising: activating a servo control system, for exerting a servo control on a spindle motor; if the servo control fails, repeatedly exerting the servo control on the spindle motor by the servo control system; turning off the servo control system if failing after repeatedly exerting the servo control on the spindle motor M times, wherein the spindle motor is to cause the optical disc to habitually rotate at a free rotation speed while the servo control system is turned off; and reactivating the servo control system and, based on the free rotation speed, determining a specified rotation speed corresponding to the free rotation speed, thereby causing the spindle motor to rotate at the specified rotation speed. The specified rotation speed corresponds to a specified optical disc access speed.

This application claims the benefit of Taiwan application Serial No. 093112831, filed May 6, 2004, the subject matter of which is incorporated herein by reference.

### BACKGROUND OF THE INVENTION

1. Field of the Invention

The invention relates in general to a method of reactivating a servo control system in an optical disc drive, and more specifically to a method of reactivating a servo control system based on a free rotation speed of a spindle motor in an optical disc drive.

2. Description of the Related Art

In a technologically advanced world today, considerable amount of multimedia information is published in a form contained in optical discs. Over the years, optical discs designed for consumer use have tremendously increased on the market. Nowadays, almost every personal computer comes equipped with an optical disc drive. Optical discs have become very important in the field of multimedia applications.

Conventionally, optical disc drives include a servo control system, a spindle motor, and an optical pick-up head. The theory of optical disc operation is characterized by the use of the servo control system to perform servo control on the spindle motor and the optical pick-up head. More specifically, the servo control includes spindle motor servo control, tracking servo control, seeking servo control, and focusing servo control.

During the manufacturing process of the optical discs, if deviations cause the manufacturing precision to stray from tolerance, then discrepancies can occur, and are often reflected in optical disc defects. As a result of such defects, optical discs often can not rotate under a constant linear velocity, CLV, or constant angular velocity, CAV, when being caused to rotate by the spindle motor under the control of the servo control system. In consequence, the servo control on the spindle motor by the servo control system is rendered ineffective. In addition to ineffective spindle motor servo control, other servo controls on the optical pick-up head by the servo control system, being in tracking servo control, seeking servo control, and focusing servo control, are also likely to become ineffective due to the discrepancies of the optical disc.

Normally, if the servo control system fails to exert the servo control on the spindle motor, then the servo control system will repeatedly exert servo control on the spindle motor so that the optical disc controlled by the spindle motor can rotate according to a preset CLV or CAV. Likewise, when the servo control system fails to exert servo control on the optical pick-up head, then the servo control system will also repeatedly exert servo control on the spindle motor so that the laser beam emitted by the optical pick-up head can accurately fall on data tracks of the optical disc.

Conventionally, if after a certain number of attempts, such as 3 attempts, servo control system is still unsuccessful in exerting the servo control on the spindle motor or the optical pick-up head and the optical disc can not be read by the optical drive, then the servo control system will automatically turn off. That is, the servo control system will automatically cease spindle motor servo control on the spindle motor, and cease tracking servo control, seeking servo control, and focusing servo control on the optical pick-up head.

After the servo control system is turned off, the optical pick-up head moves along the optical disc in a radial direction towards the inner circle of the optical disc to align with the starting data track. Also, in response to the turn off of the servo control system, the spindle motor will cause the optical disc to habitually rotate at a free rotation speed. Due to friction, air resistance and other factors, the free rotation speed of the spindle motor will decrease. Often in time, the conventional approach is to wait until the free rotation speed of the spindle motor to decease to a rotation of a lowest access speed readable by a corresponding optical pick-up head, such as 1× read speed of 2000 revs/minute, before reactivating the servo control system to repeatedly exert the servo control on the spindle motor and the optical pick-up head. The servo control system will then access the optical disc in a lowest access speed while causing the optical pick-up head to align with the data tracks on the optical disc.

However, in the aforementioned conventional method of reactivating servo control system, the time required to wait for the free rotation speed of the spindle motor to decease to a rotation of a lowest access speed readable by a corresponding optical pick-up head, such as 1× access speed with 2000 rpm, often exceeds a longest preset response time. The longest preset response time refers to the longest time allowable for the spindle motor or the optical pick-up head to respond to the servo control system to inform of whether the servo control instructed by the servo control system is successfully completed, and is often set to equal 6.5 seconds. Consequently, by exceeding over the longest preset response time, the attempt to access the optical disc by the optical disc drive will inevitably fail.

### SUMMARY OF THE INVENTION

It is therefore an object of the invention to provide a method of reactivating a servo control system, for enabling an optical disc drive to access optical discs in a more stable manner such that the optical disc is successfully read.

The invention achieves the above-identified object by providing a method of reactivating a servo control system, for applying in an optical disc drive. The optical disc drive has a servo control system and a spindle motor for causing an optical disc to rotate. The method of reactivating a servo control system includes: first, activating the servo control system to exert a servo control on the spindle motor, where the servo control system is to control a rotation speed of the spindle motor; then, if the servo control fails, repeatedly exerting the servo control on the spindle motor by the servo control system; then, turning off the servo control system if failing to exert the servo control on the spindle motor M times, where the spindle motor is to cause the optical disc to habitually rotate at a free rotation speed after the servo control system is turned off, where, preferably, M is equal to three; and reactivating the servo control system, and determining a specified rotation speed based on the free rotation speed to cause the spindle motor to rotate at the specified rotation speed.

Additionally, in the method of reactivating a servo control system, the optical disc drive further includes an optical pick-up head for accessing optical discs. In the step of reactivating the servo control system, the servo control system further exerts the servo control on the optical pick-up head, and the servo control system further controls the optical pick-up head to move in a radial direction along the optical disc. In the step of repeatedly exerting the servo control, if the servo control fails, the servo control system can further exert repeatedly the servo control on the optical pick-up head. Also, in the step of causing the spindle motor to rotate at a specified rotation speed, the optical pick-up head accesses data on the optical disc at the specified optical disc access speed. Furthermore, in the step of repeatedly exerting the servo control, the optical pick-up head is to move in a radial direction along the optical disc towards the inner track of the optical disc after the servo control system is turned off.

In the above mentioned method of reactivating a servo control system, the optical pick-up head can output a laser beam, and the servo control system is to control the optical pick-up head to move in a radial direction along the optical disc, so that the laser beam output by the optical pick-up head falls accurately on a data region of the optical disc. Also, the optical pick-up head includes an object lens. The servo control system can further be utilized for controlling the object lens to move perpendicularly with respect to the optical disc, so that the laser beam is focused on the data region of the optical disc.

According to another object of the invention, a method of reactivating a servo control system for applying in an optical disc drive is provided. The optical disc drive includes a servo control system, a spindle motor for causing an optical disc to rotate, and an optical pick-up head for accessing the optical disc, and the method is characterized by: reactivating the servo control system, and determining, in accordance with a free rotation speed of the spindle motor, a specified rotation speed corresponding to the free rotation speed, thereby causing the spindle motor to rotate at the specified rotation speed, and the specified rotation speed corresponds to a specified optical disc access speed.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a flow diagram illustrating a method of reactivating a servo control system according to a preferred embodiment of the invention.

### DETAILED DESCRIPTION OF THE INVENTION

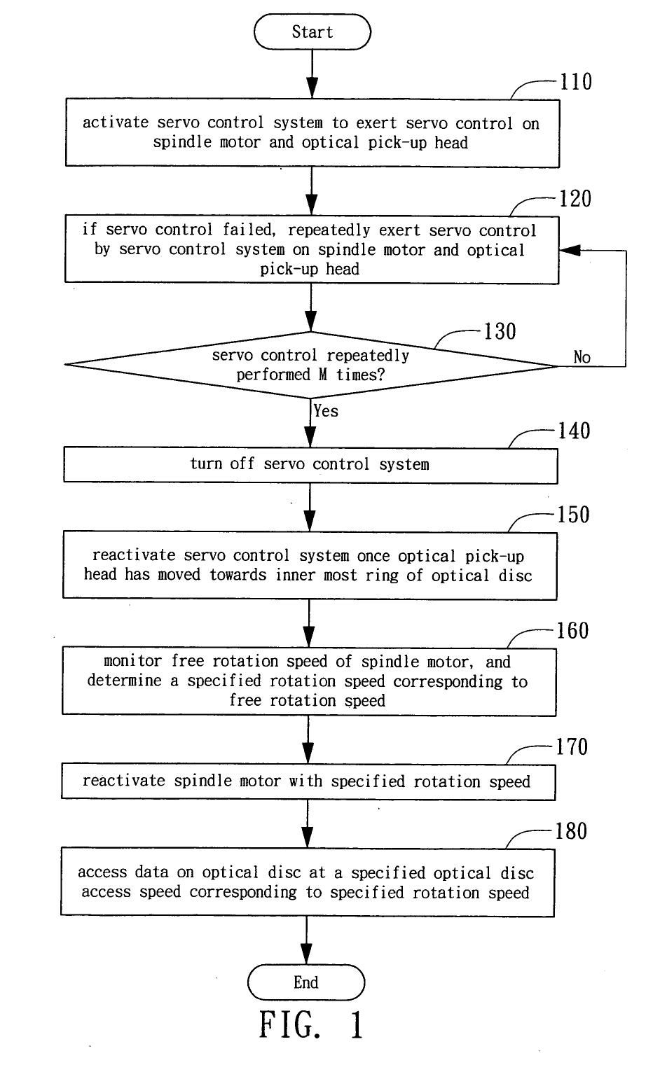

Referring to FIG. 1, a flow diagram illustrating a method of reactivating a servo control system according to a preferred embodiment of the invention is shown. The method of reactivating a servo control system is preferably applied in an optical disc drive. The optical disc drive includes a servo control system, a spindle motor, and an optical pick-up head.

The method of reactivating a servo control system includes the following steps. First, the method of reactivating a servo control system begins at step 100. Next, in step 110, the servo control system is activated to exert a servo control on the spindle motor and the optical pick-up head. During this time, the servo control system is to control a rotation speed of the spindle motor, to control the optical pick-up head to move in a radial direction along the optical disc, and also to control the focus of the laser beam, outputted by the optical pick-up head, on data tracks of the optical disc.

Then, in step 120, if the servo control fails, then the servo control system repeatedly exerts the servo control on the spindle motor and the optical pick-up head. Then, in step 130, the servo control system determines whether the servo control has been repeatedly performed on the spindle motor and the optical pick-up head for M times. If not, then step 120 is returned to resume the servo control. If yes, then step 140 is performed. In the design of an optical disc drive, M is preferably set to equal 3.

Next, in step 140, after failing to exert the servo control on the spindle motor M times, the servo control system is turned off. After that, the spindle motor is caused to habitually rotate at a free rotation speed, while the optical pick-up head is caused to move towards the inner track of the optical disc.

Subsequently, in step 150, once the optical pick-up head has moved towards the inner most track of the optical disc to re-align with the starting data track, the servo control system is reactivated. Then, the servo control system exerts control on the spindle motor and the optical pick-up head based on the free rotation speed of the spindle motor at that instant.

Next, in step 160, the servo control system monitors the free rotation speed, and determines a specified rotation speed corresponding to the free rotation speed. More precisely, the specified rotation speed is a rotation speed of the spindle motor that corresponds to one of the optical disc access speeds. To better demonstrate, suppose that the optical disc drive is to access data of the optical disc at 2×, 4×, 8× optical disc access speeds, then the rotation speeds of the spindle motor are respectively 2400, 3600, 4800 rpm. Then, suppose that at that particular instant the free rotation speed of the spindle motor is 2500 rpm, then the servo control system of the optical disc drive will select the closest rotation speed from the available optical disc access speeds that corresponds to the spindle motor rotation speed. Namely, servo control system will select 2× optical disc access speed as the specified rotation speed that corresponds to 2400 rpm, being that 2400 rpm from the available optical disc access speeds is closest to the free rotation speed of 2500 rpm.

Then, entering step 170, the servo control system reactivates the spindle motor with the specified rotation speed. That is, the servo control system causes the spindle motor to rotate at the specified rotation speed of 2400 rpm, while also causing the optical disc to rotate.

In step 180 that follows, the optical pick-up head accesses the data on the optical disc at a specified optical disc access speed corresponding to the specified rotation speed. Namely, servo control system is to access the data on the optical disc at a 2× optical disc access speed corresponding to the specified rotation speed of 2400 rpm.

Alternatively saying, from steps 160 to 180, reactivating the servo control system for performing the servo control on the spindle motor and the optical pick-up head will enable the spindle motor to rotate the optical disc at the specified rotation speed that is close to the free rotation speed of the spindle motor. That is, while reactivating the spindle motor to rotate, the rotation speed of the spindle motor is close to the specified rotation speed of the free rotation speed of the spindle motor, where the specified rotation speed is the spindle motor rotation speed corresponding to a specified optical disc access speed. After causing the optical pick-up head to align with the data track of the optical disc, the servo control system accesses the data of the optical disc at the specified optical disc access speed.

Moreover, the embodiment can incorporate a built-in table in the optical disc drive to include the free rotation speed and the corresponding specified rotation speed of the spindle motor, so that the servo control system can quickly lookup for a specified rotation speed corresponding to a free rotation speed from the built-in table.

Further in discussion, in the embodiment, the invention further provides a method of reactivating a servo control system of an optical disc drive, for applying to the servo control system after failing to exert the servo control on the spindle motor and the optical pick-up head M times. The steps involved in this method include, first, turning off the servo control system, thereby causing the spindle motor to rotate the optical disc at a free rotation speed, as shown in step 140 and 150. Then, based on the free rotation speed of the spindle motor, the servo control system is reactivated. The servo control system exerts the servo control on the spindle motor, thus enabling the spindle motor to rotate the optical disc at the specified rotation speed that is close to the free rotation speed, as indicated by steps 160 and 170. The specified rotation speed corresponds to a specified optical disc access speed.

In the above mentioned embodiment, the servo control of the optical pick-up head by the servo control system to move in a radial direction along the optical disc includes the tracking servo control and the seeking servo control. In addition, in the servo control of the optical pick-up head by the servo control system further includes a focusing servo control.

The optical pick-up head can be utilized to output a laser beam, and the optical disc includes a data region. The servo control system controls the optical pick up head to move in a radial direction along the optical disc so that the laser beam output by the optical pick-up head can fall accurately on the data region of the optical disc. For the focusing servo control on the optical pick-up head, the servo control system is to control the object lens of the optical pick-up head to move perpendicularly with respect to the optical disc, such that the laser beam can be focused on the data region of the optical disc.

In the above mentioned embodiment, after the servo control system is turned off, the servo control system is to be reactivated again after the optical pick-up head has reached the inner most track of the optical disc and has re-aligned with the starting data track. While being reactivated, based on the free rotation speed of the spindle motor at that instant, the servo control system is to set a rotation speed that is close to the free rotation speed of the spindle motor in order to rotate the optical disc. The proposed method of reactivating the servo control system differs from the conventional method in that the conventional servo control system can only be reactivated when the free rotation speed of the spindle motor in habitual rotation drop to a speed corresponding to the lowest optical disc access speed accessible by the optical pick-up head.

Thus, by using the method of reactivating a servo control system according to the embodiment of the invention, the loss of precious time while waiting for the spindle motor to increase or decrease rotation speed after the servo control system is turned off and reactivated. The time taken for the servo control system to turn-off and be reactivated will not exceed the longest time reserved for the spindle motor or the optical pick-up head to reply to the servo control system to inform whether the servo control instructed by the servo control system has been completed.

Accordingly, by applying the method according to the embodiment of the invention, the optical disc drive can access optical discs in a more stable manner to thereby ensure the success of the optical disc drive in accessing optical discs.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of reactivating a servo control system of an optical disc drive, the optical disc drive having a spindle motor for causing an optical disc to rotate, the method comprising:
activating the servo control system, for exerting a servo control on the spindle motor, wherein the servo control is to control a rotation speed of the spindle motor;
repeatedly exerting the servo control on the spindle motor by the servo control system if the servo control fails;
turning off the servo control system if failing to exert the servo control on the spindle motor M times, wherein the spindle motor is to cause the optical disc to habitually rotate at a free rotation speed after the servo control system is turned off; and
reactivating the servo control system, and determining a specified rotation speed based on the free rotation speed, for causing the spindle motor to rotate at the specified rotation speed;
wherein the specified rotation speed corresponds to a specified optical disc access speed.

2. The method according to claim 1, wherein M equals to three.

3. The method according to claim 1, wherein the optical disc further has an optical pick-up head for accessing the optical disc, during the step of reactivating the servo control system, the servo control system further exerts the servo control on the optical pick-up head, and the servo control system further controls the optical pick-up head to move in a radial direction along the optical disc, during the step of repeatedly exerting the servo control, the servo control system is further used to repeatedly exert the servo control on the optical pick-up head, and during the step of causing the spindle motor to rotate at a specified rotation speed, the optical pick-up head is to access data on the optical disc at the specified optical disc access speed.

4. The method according to claim 1, wherein the optical disc further has an optical pick-up head for accessing the optical disc, during the step of repeatedly exerting the servo control, after the servo control system is turned off, the optical pick-up head is to move in a radial direction along the optical disc towards the inner track of the optical disc.

5. The method according to claim 1, wherein the optical pick-up head outputs a laser beam, the optical disc has a data region, the servo control system is to control the optical pick-up head to move in a radial direction along the optical disc, so that the laser beam output by the optical pick-up head falls accurately on the data region of the optical disc.

6. The method according to claim 1, wherein the optical pick-up head outputs a laser beam, and the optical pick-up head has an object lens, the optical disc has a data region, the servo control system is further used for controlling the object lens to move perpendicularly with respect to the optical disc, so that the laser beam is focused on the data region of the optical disc.

7. A method of reactivating a servo control system, for applying in an optical disc drive, the optical disc drive has a servo control system, a spindle motor for causing an optical disc to rotate, and an optical pick-up head for accessing the optical disc, and the method is characterized by:
reactivating the servo control system, and determining, based on a free rotation speed of the spindle motor, a specified rotation speed corresponding to the free rotation speed, for causing the spindle motor to rotate at the specified rotation speed;
wherein the specified rotation speed corresponds to a specified optical disc access speed.

8. The method according to claim 7, wherein the optical pick-up head outputs a laser beam, the optical disc has a data region, the servo control system is to control the optical pick-up head to move in the radial direction along the optical disc, so that the laser beam output by the optical pick-up head falls accurately on the data region of the optical disc.

9. The method according to claim 7, wherein the optical pick-up head outputs a laser beam, and the optical pick-up head has an object lens, the optical disc has a data region, the servo control system is further used for controlling the object lens to move perpendicularly with respect to the optical disc, so that the laser beam is focused on the data region of the optical disc.

10. The method according to claim 7, wherein the optical pick-up head is to access data on the optical disc at the specified optical disc access speed.

11. A method of reactivating a servo control system for an optical disc drive, for applying after the servo control system has failed M times to exert a servo control on a spindle motor of the optical disc drive, the spindle motor for causing an optical disc to rotate, the method comprising:
turning off the servo control system, thereby causing the spindle motor to rotate the optical disc at a free rotation speed; and
reactivating the servo control system according to the free rotation speed, the servo control system exerting the servo control on the spindle motor, thereby causing the spindle motor to rotate the optical disc at a specified rotation speed close to the free rotation speed, the specified rotation speed corresponding to a specified optical disc access speed.

12. The method according to claim 11, wherein the optical disc drive further has an optical pick-up head for accessing the optical disc, the step of turning off the servo control system further comprises:
turning off the servo control system, causing the spindle motor to rotate the optical disc at a free rotation speed, and the optical pick-up head is to move along the optical disc in a radial direction towards the inner circle of the optical disk.

13. The method according to claim 11, wherein the step of reactivating the servo control system further comprises:
accessing data of the optical disc by the optical pick-up head at the specified optical disc access speed.

14. The method according to claim 11, wherein M equals to three.
